(19) United States
(12) Patent Application Publication
(10) Pub. No.: US 2005/0268248 A1
(43) Pub. Date: Dec. 1, 2005

(54) Content customization with resizability and context-sensitivity

(75) Inventors: Daniel Boerner, Seattle, WA (US); Randall Friend Kern, Bellevue, WA (US); Laura Baldwin, Seattle, WA (US)

Correspondence Address: WOODCOCK WASHBURN LLP, ONE LIBERTY PLACE - 46TH FLOOR, PHILADELPHIA, PA, 19103, US

(73) Assignee: Microsoft Corporation, Redmond, WA (US)

(21) Appl. No.: 10/853,037

(22) Filed: May 25, 2004

(51) Int. Cl. G06F 3/00; G06F 17/00

(52) U.S. Cl. 715/788; 715/800; 715/866; 715/517; 715/523; 715/526; 715/522

(57) ABSTRACT

Mechanisms are disclosed for delivering web content in a manner that allows user-specified manipulation of the content to be processed client side. An example web page comprises a plurality of modules organized into columns. The column widths can be resized by the user, and the modules can be moved from one column to another, or to different locations within a column. The various components of content within a module are delivered with attributes indicating whether the a given component is to be displayed or hidden at a particular column width. When a column is resized by the user, the amount of content that is displayed or hidden is adjusted based on the new column width.

### FIELD OF THE INVENTION

The present invention relates generally to the field of computing, and, more particularly, to web pages that have resizable modules, and where the content displayed in a module is responsive to the relevant context such as the size at which the module is being displayed.

### BACKGROUND OF THE INVENTION

In providing customization of web pages, one goal is to provide users with control over not only the content that appears on such pages, but also the way in which such content is presented. Content is generally controlled by selecting from a library of generalized modules, and by customizing more specific modules such as weather forecasts or stock quotes with settings to control the data displayed within these modules. Conventionally, end-user control over presentation has been primarily limited to the style of the page—e.g., by providing a gallery of themes that can be applied to the pages to change the colors, background images, and so on.

However, in many cases it is desirable to allow users control over a greater number of variables regarding how a page is displayed. For example, a page may be composed of different pieces of content, and the user may wish to move these pieces around the page or to resize them. While some systems may allow certain limited degrees of user control in these areas, the control is generally exercised by communicating the user's selections to the server, and then having the server re-create the page in accordance with the user's choices and re-deliver a newly-created page to the user for rendering on the user's browser. Thus, the user's computer functions essentially as a passive renderer of content, and all processing of a user's choices requires a round-trip to the server. This structure is undesirable for systems in which frequent and dynamic user control over content is expected to take place.

In view of the foregoing, there is a need for a system that overcomes the drawbacks of the prior art.

### SUMMARY OF THE INVENTION

The present invention provides mechanisms that enable a high degree of user-customization of remotely delivered content, such as a web page. Content is delivered in the form of a web page that comprises one or more columns, as well as “modules” that may be placed in the columns. Each module is composed of various content components, and each component can have an attribute associated therewith that indicates whether the component is to be displayed or hidden at particular column widths. The user may resize the columns, and may move a module from one column to another. When a column is resized, or when a module is placed in a column having a different size than the one in which the module had previously been located, client-side logic causes a given component within the module to be either displayed or hidden depending on whether the attributes associated with that component indicate that the component is to be displayed or hidden at the current column width. Thus, modules are delivered with all of the content components that could potentially be displayed as part of the module, and logic residing at the user's machine causes different components to be displayed or hidden based on the attributes of the module's content and the user-settable column width. In other words, from the user's perspective the module appears to be aware of its rendered context (e.g., the width of the column in which it is located), and can change its appearance to provide the data that is most relevant within this context.

In a preferred embodiment, column widths are classified into discrete categories—e.g., small, medium, large, and extra large. Each content component in a module (e.g., a piece of text) is associated with zero or more attributes that indicate which category(ies) of column widths should cause that component to be hidden. For example, the attributes may indicate that a particular component (e.g., a current stock price in a stock-ticker module) should be hidden if the current column width is small, but should be displayed at any other column width. In a preferred embodiment, categories of column widths may be defined based on the number of pixels that span the width of the column (e.g., any column whose with is less than 251 pixels may be a “small” column).

In general, the user can resize a column to any width, and the current view of the modules will be adapted in accordance with the technique described above. Additionally, a module may be assigned a minimum width, and client-side logic may ensure that the user is not resizing the column to a width that is smaller than the largest minimum width for all modules present in the column. An attempt to resize the column below such a width may result in rejection of the user's attempt to resize the column.

Other features of the invention are described below.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings example constructions of the invention; however, the invention is not limited to the specific methods and instrumentalities disclosed. In the drawings:

FIG. 1 is a block diagram of an example computing environment in which aspects of the invention may be implemented;

FIG. 2 is a block diagram of an example web page that comprises columns and modules;

FIG. 3 is a block diagram of an example module; and

FIG. 4 is a flow diagram of an example method for processing a request to resize a column, in accordance with aspects of the invention.

### DETAILED DESCRIPTION OF ILLUSTRATIVE EMBODIMENTS

Exemplary Computing Arrangement

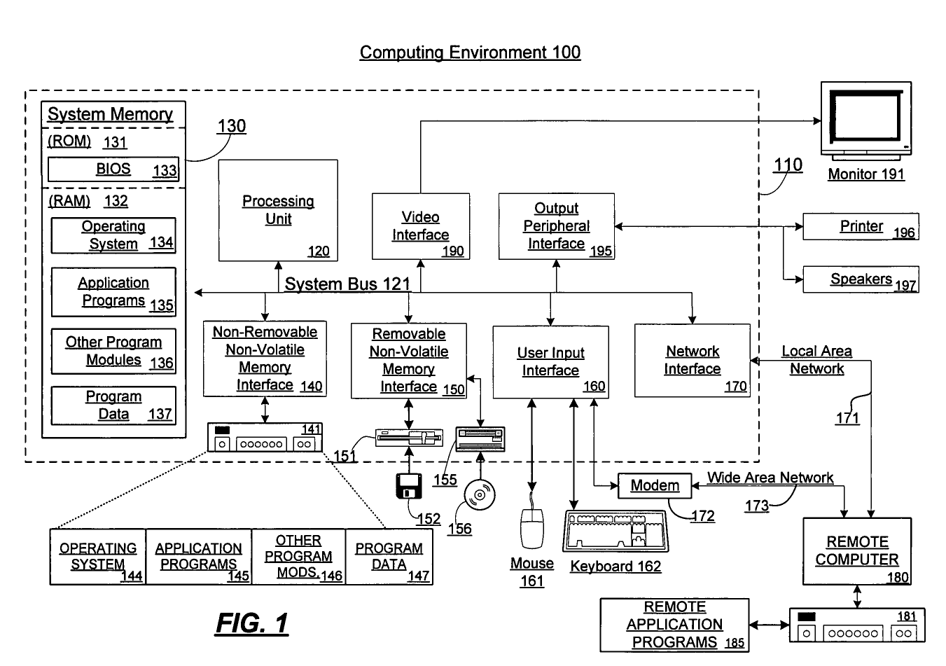

FIG. 1 shows an exemplary computing environment in which aspects of the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Example Web Page with Resizable Columns

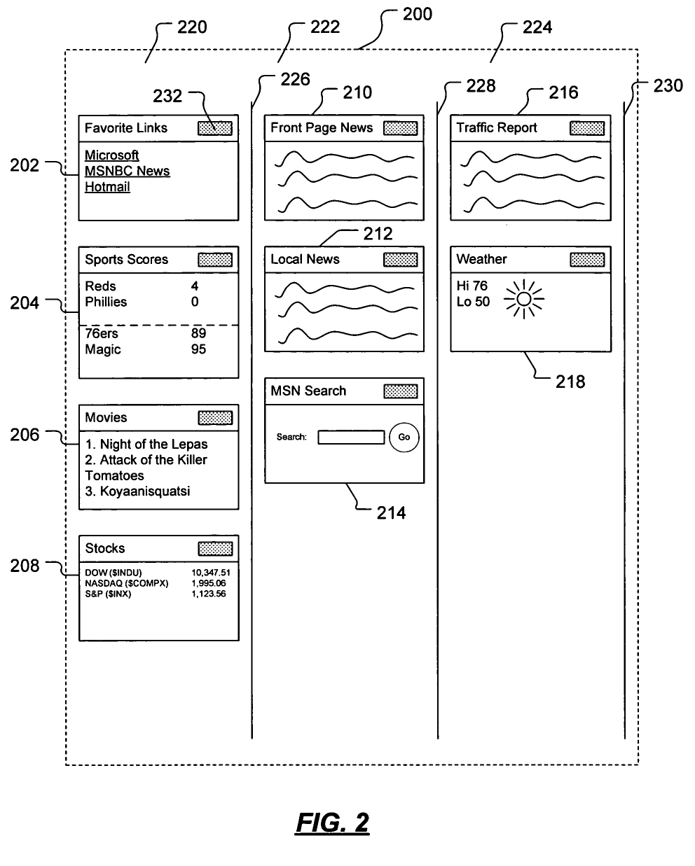

FIG. 2 shows an example of a web page 200, which uses resizable columns and context-sensitive modules in accordance with aspects of the invention. Web page 200 comprises content. As is known in the art, this content is typically in Hypertext Markup Language (HTML) format, and can be rendered on the user's computer by a web browser, such as the INTERNET EXPLORER browser.

In the example of FIG. 2, web page 200 comprises a plurality of modules 202, 204, 206, 208, 210, 212, 214, 216, 218. Each module comprises content that is located in one of columns 220, 222, or 224. Each of the columns 220, 222, and 224 is resizable, in the sense that each of the columns can be made narrower or wider. Column boundaries 226, 228, 230 mark the ends of columns 220, 222, and 224, respectively, and each column can be made wider or narrower by moving its corresponding boundary to the right or left. For example, a user can make column 220 wider by using a pointing device (e.g., pointing device 161, shown in FIG. 1) to move column boundary 226 to the right; similarly, the user can make column 220 narrower by moving column boundary 226 to the left.

A module is, in a preferred embodiment, a “draggable” object, in the sense that it can be moved from column to column, or can be moved to a different vertical location within a column. In the example of FIG. 2, each module includes a dragging box 232. Using a pointing device, the user click on a module's dragging box to grab the module, move it to another column or to another vertical location within a column, and then release the module at its new location. When a module is moved, it acquires the width of the column to which it has been moved. For example, a user can move module 202 from column 220 to column 224, and doing so causes module 202 to change its width from that of column 220 to that of column 224.

The width of a module can be significant, because, in accordance with aspects of the invention, the nature and amount of content displayed depends on the module's current width. For example, a module can be delivered to a web page with plural content components, but each of the content components may be designated to be displayed, or to be hidden, depending on the module's current width. Thus, at any given point in time, the content that is being displayed can be made to depend on the current width of the module, and, therefore, on the column in which the module is currently placed. It should be noted that changing which components of the content are currently being displayed preferably does not require redelivery of the module from the server; rather, the module is delivered with all of the content that it could potentially display, and the decision is made at the user (client) machine as to which components will be displayed or hidden, based on the current width of the module. For example, module 206 shows a list of movies. That module may also contain a list of the last week's gross receipts for each movie on the list, but that information is hidden in FIG. 2 because module 206 is not sized wide enough; if module 206 were sized wider, then it might display the gross receipt information. Similarly, module 208 shows certain stock indices together with their current value, but may also contain information about the change in value relative to yesterday's closing price; this additional information is hidden at the current width of module 208 that is shown in FIG. 2, but might be displayed if module 208 were sized wider, either by resizing its current column or by placing it in a wider column. (It should be noted that, while the above examples refer to additional content being displayed as a column grows wider, it should be noted that content displayed at one width is not necessarily displayed at a wider width. As more particularly described below, a module can arbitrarily specify at which column widths (or, at least, at which categories of column width) a given piece of content within a module will be displayed.) A mechanism that enables a module's content to be displayed or hidden based on the width of the module is more particularly described below.

Resizable Column Widths and Column-Width Attributes

In accordance with one feature of the invention, columns may be classified based on their width—for example, a column may be classified as being small (s), medium (m), large (l), or extra large (xl), based on the current number of pixels that span the width of the column. Moreover, the various components of a given module's content may be assigned attributes that indicate whether a particular component is to be displayed or hidden in a particular width category. Thus, a module may contain a content component that is marked to be always displayed; or such a component may be marked to be hidden when the module is in a small column, but to be displayed if the module is in a column having any other size. All content in a module—regardless of the attributes associated with that column—may be delivered to the client's computer, and the client's computer may contain logic that determines, based on the width of the column in which the module is located, whether a particular component of the module's content is to be displayed or hidden.

The classification of columns as being small, medium, large, or extra large, can be defined as in the following example:
small=less than 251 pixels wide;
medium=between 251 and 308 pixels wide;
large=between 309 and 360 pixels wide;
extra large=greater than 360 pixels wide.
   While the above example shows the case where there are four different column width classifications having certain names and certain ranges of pixels, it should be noted that the invention is not limited to this example. In general, there may be any number of different column width classifications, and these classifications may be defined in any manner (e.g., based on the number of pixels that span the column's width as above, or using any other type of measurement).

At any given point in time, a column may have the attribute col_s, col_m, col_l, or col_xl, indicating that the column's width is small, medium, large, or extra large, respectively. Additionally, each component of a module's content may be assigned one or more of the attributes hide_s, hide_m, hide_l, and/or hide_xl. Each of these attributes indicates that the content to which it applies is to be hidden (i.e., not displayed) when the column in which the module is located has a particular size. Thus, if the module is located in a column that currently has the attribute col_s, then any content in the module that has been assigned the attribute hide_s will not be displayed. Similarly, if the module is located in a column that has the attribute col_m, then any content in the module that has been assigned the attribute hide_m will not be displayed.

The following tables shows, for each type of attribute, whether a content component having that attribute would be displayed in a column having a particular width:

| | Small | Medium | Large | Extra Large |
|---|---|---|---|---|
| | Column | Column | Column | Column |
| | (col_s) | (col_m) | (col_l) | (col_xl) |
| hide_s | Hidden | Displayed | Displayed | Displayed |
| hide_m | Displayed | Hidden | Displayed | Displayed |
| hide_l | Displayed | Displayed | Hidden | Displayed |
| hide_xl | Displayed | Displayed | Displayed | Hidden |

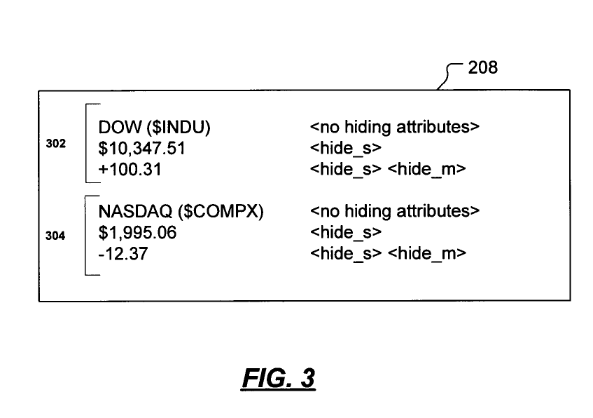

For example, FIG. 3 shows module 208 with the hiding attributes of the various components of its content. (In a preferred embodiment, content would be described in HTML, with attributes described with tags in a manner that is consistent with the HTML language; the format of module 208 shown in FIG. 3 is for illustrative purposes only.) As shown in FIG. 2, module 208 lists a stock or stock index, and its current price, on each line. Thus the first line 302 contains the name of a stock index (“DOW ($INDU)”) and a current price (“$10,347.51”). Each component of content is associated with attributes that indicate at which column size (small, medium, large, or extra large) the content is to be hidden. Thus, the first component (“DOW ($INDU)”) has no hiding attribute; this component, therefore, is displayed regardless of the size of the column in which module 208 is placed. The second component (“$10,347.51”) is marked with the attribute “hide_s”; this component is hidden if the current column size is “small,” but is displayed if the module is sized at any other column width. As noted above, module 208 may also contain information about the current price's change in value relative to the previous day's closing price—in this case “+100.31”. This component has the attributes “hide_s” and “hide_m,” which means that it will be hidden for small and medium columns, but will be displayed for large and extra large columns. In FIG. 2, module 208 is sized too narrowly to display this component of content, and thus the content is hidden. However, this component is still part of the underlying content, and is therefore delivered as part of module 208; client-side logic causes this component not to be displayed if the current column size is one of the column widths for which the content has been marked as hidden. (It should be noted that “hide_m” does not necessarily imply “hide_s”; it is possible to create content that will be hidden for a medium size column but not for a small column. Thus, if the content creator intends for content to be hidden for all columns that are medium or smaller, then both the hide_s and hide_m attributes should be set.)

### Example Process for Processing a User Action

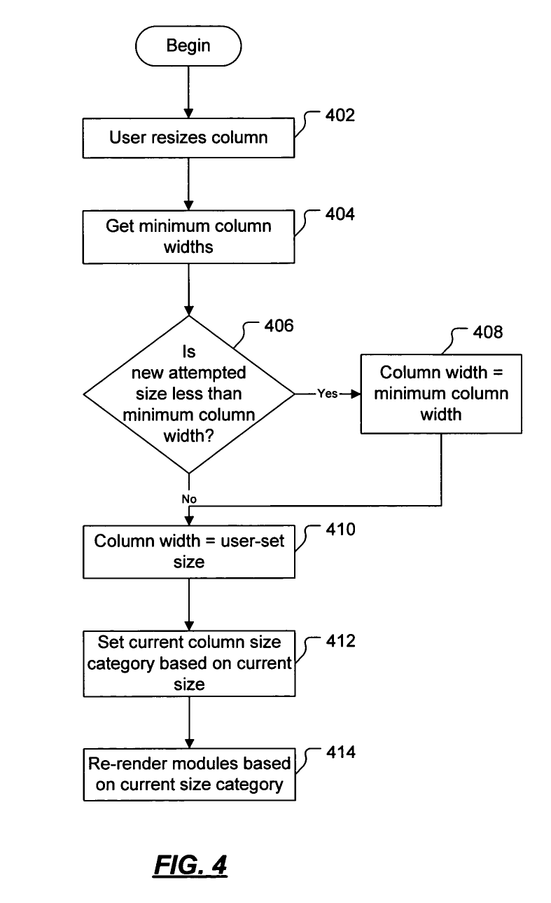

As noted above, a user may indicate that the view of a web page is to be changed, and the view may be changed by logic that resides on the user's machine. As one example the user may resize a column of the page, which, in turn, may cause the modules in that column to display different information that was displayed at the previous column width. FIG. 4 shows an example process by which a user's request to resize a page is processed.

Initially, the user directs that a column is to be resized (402). For example, the user may use a pointing device to move the boundary of a column horizontally, thereby indicating a change in the column's width. Client-side logic then assesses the minimum required width for the column, by retrieving the minimum widths for each of the modules in the column and finding the maximal value among these minimum widths (404). If the new width that the user has attempted to set is less than the minimum width for the column (406), then the column width is set to the minimum allowable width (408) (or, as an alternative, the resize request may be rejected entirely). If the new width set by the user is not less than the minimum width for the column, then the width of the column is set to the value specified by the user (410). After the new column width has been set (either at 408 or 410), the column's width category (e.g., small, medium, large, or extra large) is set based on which range the column's current width falls into (412). Next, the content that is displayed in each of the modules is adjusted to hide or display content components depending on whether a component's attributes indicate that the component is to be displayed or hidden at the current column width category.

The following are example functions, depicted in the form of Java, which can be used to perform the actions described in FIG. 4.

Client-Side Javascript Routines for Resizable Columns

// The following function sets the width and class name on the column being resized

// It is called from the onmousemove handler
// col is the column being resized
// coords is the object returned by the getCoords( ) function
for the column being resized
// delta is the net change of the width of the column being resized
function updateColumnSize(col, coords, delta) {
var w0 = col.width;

var cls = col.className.split(‘ ’)[0];
var w = Math.max(getColMinWidth(col), (coords.width + delta));
if (w != w0 && w > 0) {

if (w < 251) {

cls += “ col_s”;

}
else if (w < 309) {

cls += “ col_m”;

}
else if (w < 361) {

cls += “ col_l”;

}
else {

cls += “ col_xl”;

}
col.className = cls;
col.width = w;
return w;

}
return null;

}

// The following function returns the minimum width for the column being passed by inspecting the columns children

function getColMinWidth(col) {

var p = coerceInt(col.currentStyle.paddingLeft) +

coerceInt(col.currentStyle.paddingRight);

var w = col.clientWidth + p;
var t = col.children;
for(var j=0; j<t.length;j++) {

w = Math.max(w, t[j].scrollWidth + p);

}
return (w != col.clientWidth + p) ? w: null;

}

// The following function returns an object that provides properties with the actual dimensions and position

// of the element passed
function getCoords(el) {

if (!el) {

return null;

}
var c = new Object( );
var s = el.currentStyle;
c.height = el.offsetHeight + coerceInt(s.marginTop) +
coerceInt(s.marginBottom);
c.width = el.offsetWidth + coerceInt(s.marginLeft) +
coerceInt(s.marginRight);
c.left = 0;
c.top = 0;
while (el && el.tagName != ‘BODY’) {

c.left += el.offsetLeft;
c.top += el.offsetTop;
el = el.offsetParent;

}
c.bottom = c.top + c.height;
c.right = c.left + c.width;
return c;

}
function coerceInt(i) {

i = parseInt(i);
return i.toString( ) == “NaN” ? 0 : i;

}

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

1. A computer-readable medium encoded with computer-executable instructions to perform a method of processing user-supplied instructions regarding a content format, the method comprising:
receiving, from a user, a specification of a first size of a first column of a unit of content, said unit of content comprising one or more columns including said first column, one or more modules being displayed in said first column;
determining, based on said first size, that said first column is in a first size category, said first size category being one of a plurality of pre-defined size categories; and
hiding any content components in each of said one or more modules that have been marked to be hidden when said module is being displayed at a size in said first size category.

2. The computer-readable medium of claim 1, wherein said specification indicates a width of said first column.

3. The computer-readable medium of claim 2, wherein each of said one or more modules is associated with a minimum width at which such module must be displayed, and wherein the method further comprises:
determining the greatest minimum width from among all of said one or more modules to compute a maximal minimum width; and
if said first size is at least as great as said maximal minimum width, the setting a size of said column to said first size, and otherwise setting said size to said maximal minimum width.

4. The computer-readable medium of claim 1, wherein said column is displayed with a visual demarcation of its boundaries, and wherein said specification is provided by a user's use of a pointing device to move said boundaries.

5. The computer-readable medium of claim 1, wherein each of said one or more modules comprises a plurality of content components, at least one of the content components being associated with an attribute indicating that said one of the content components is to be hidden when the module with which said one of the content components is displayed at a size in said first size category.

6. The computer-readable medium of claim 1, further comprising:
displaying any content components in each of said one or more modules that have not been marked to be hidden when said module is being displayed at a size in said first size category.

7. The computer-readable medium of claim 1, wherein the method is performed at a first computing device, and wherein said unit of content is provided to said first computing device by a second computing device remote from said first computing device, and wherein said method is performed at least one time without said unit of content being re-delivered from said second computing device to said first computing device during performance of the method.

8. A computer-readable medium encoded with computer-executable instructions to perform a method of displaying a content module, the method comprising:
receiving a module, said module comprising a plurality of content components, at least a first one of said content components being associated with an attribute that indicates whether said first one of said content components is to be displayed when said module is rendered in a first size category, said first size category being one of a plurality of size categories;
determining whether said module is being rendered at said first size category;
if said module is being rendered at said first size category, then either displaying or hiding said first one of said content components in accordance with said attribute.

9. The computer-readable medium of claim 8, wherein said first size category indicates a width of said module.

10. The computer-readable medium of claim 8, wherein said module is located in a column, said column being sizable upon a user specification, and wherein said module's size category is based on a dimension of said column's size.

11. The computer-readable medium of claim 10, wherein said column is assigned a with by said user specification, and wherein said module's width is defined to be equal to the width of said column in which said module is located.

12. The computer-readable medium of claim 8, wherein said module is described in extensible Markup Language (XML), and wherein said attribute is expressed as a tag in XML.

13. A system for rendering content comprising:
a rendering program that receives content from an external source and that renders said content in accordance with instructions included in said content, said content comprising a plurality of components, each of said components being associatable with one or more attributes indicating a context in which said component is to be rendered or hidden; and
logic that causes each of said plurality of components to be rendered or hidden based on a context in which said content is to be rendered and the one or more attributes associated with each component.

14. The system of claim 13, wherein the context in which said content is to be rendered comprises a width, and wherein each of the one or more attributes indicate one or more widths at which each of the plurality of content components is to be rendered or hidden.

15. The system of claim 14, wherein said width is specifiable by a user of a computing device at which said rendering program operates.

16. The system of claim 15, wherein said width is specificable by a user of a computer device at which said rendering program operates without control by said external source.

17. The system of claim 13, wherein said content comprises a first module, said module being part of a page that comprises a plurality of modules laid out in one or more columns, said context being defined by factors comprising: which of said columns said first module is located in, and the width of the column in which said first module is located.

18. A method of creating content on a first computing device that is to be rendered on a second computing device, the method comprising:
at the first computing device, creating a unit of content that comprises:
a first portion that is displayable on the second computing device in a first context; and
a second portion that is displayable on the second computing device in a second context; and
delivering the unit of content to the second computing device, there being logic at the second computing device that determines whether said first portion and/or said second portion are to be displayed based on a context present at said second computing device.

19. The method of claim 18, wherein said unit of content comprises a plurality of columns and a plurality of modules, each of the modules being locatable in one of the plurality of columns, the location of a module being changeable by instructions receivable from a user of the second computing device.

20. The method of claim 19, wherein each of the modules comprises a plurality of components, at least some of said components being associated with an attribute indicating that such components are part of said first portion, and at least some of said components being associated with an attribute indicating that such components are part of said second portion.

21. The method of claim 19, wherein said first context constitutes a first rendering width, and wherein said second context comprises a second rendering width, said first portion and said second portion being displayable or hidden based on a width at which a module is to be rendered.
